(19) United States
(12) Patent Application Publication
(10) Pub. No.: US 2023/0328048 A1
(43) Pub. Date: Oct. 12, 2023

(54) Mutable Cryptographic Digital Multimedia Assets

(71) Applicants: Benji Kip Rogers, Brooklyn, NY (US); Stephen John Godfrey, Brooklyn, NY (US); Jann Tosatto, Amsterdam (NL)

(72) Inventors: Benji Kip Rogers, Brooklyn, NY (US); Stephen John Godfrey, Brooklyn, NY (US); Jann Tosatto, Amsterdam (NL)

(21) Appl. No.: 17/658,289

(22) Filed: Apr. 7, 2022

(51) Int. Cl. H04L 9/40; H04L 9/00

(52) U.S. Cl. CPC H04L 63/0471; H04L 9/50

(57) ABSTRACT

Presented are mutable cryptographic digital multimedia assets, methods for creating, transferring, updating, and playing such cryptographic digital multimedia assets, and decentralized computing systems with blockchain control logic for tracking the accessing, playing, displaying, transfer, or other consumption of those assets, and consequently altering them by digitally updating, altering, limiting, degrading, watermarking, or eventually destroying those digital multimedia assets.

### CROSS-REFERENCE TO RELATED APPLICATIONS

The present application claims the benefit of priority to U.S. Provisional Patent No. 63/172,774, filed on 9 April. 2021, which is hereby incorporated by reference in its entirety.

### PRIOR ART

There have been a number of recent developments in cryptographic digital assets and Non-Fungible Tokens (NFT's) which are relevant prior art to the invention described herein.

Prior patents describe various process related to the creation or transmission of cryptographic digital assets or NFT's which are static or unchanging in nature. This includes US Patent No US 2021/0097508 A1 which describes a system and method for creating, tracking and transferring non-fungible tokens on a distributed ledger; US Patent No US 2021/0150626A1 which describes a method for storing distinguishing characteristics of fungible and non-fungible tokens in a distributed ledger; U.S. Pat. No. 11,032,072 B2 describes a system and method for providing cryptographically secured digital assets related to articles of digital footwear, including real-world articles of footwear, which in some embodiments may breed to generate new unique digital footwear.

Prior patents describe processes relating to altering cryptographic digital assets or NFT's in certain unique or limited circumstances, however none of these patent describe cryptographic digital assets or NFT's whose contents updates or changes. This includes South Korean Patent No KR 102151895B1 which describes a method of merging two compatible smart assets.

Prior patents describe cryptographic digital assets or NFT's which interact in some way with the external world, however none of these patent describe cryptographic digital assets or NFT's whose contents updates or changes. This includes US Patent No US 2020/0242105 A1 which describes a platform for creating and using actionable non-fungible tokens in which a change to the blockchain ledger may occur as a result of a social actions such as a user comment, connection, direct message, like, or favorable rating on an internet platform; and US Patent No US 2021/0357489 A1 which describes a communication network based non-fungible token creation platform with integrated creator biometric authentication and their geo-location data

Prior patents describe cryptographic digital assets or NFT's related to collectibles, however none of these introduce the elements of increasing scarcity which are present in this invention, nor do their contents update or change. This includes US Patent No US 2022/0058630 A1 which describes a non-fungible-token-based celebrity autograph platform; U.S. Pat. No. 11,032,072 B2 which describes a system and method for providing cryptographically secured digital assets related to collectible articles of digital footwear, including real-world articles of footwear; and US Patent No US 2021/0201336 A1 which describes an apparatus and method for managing branded digital items which is associated with a non-fungible token.

Prior patents describe cryptographic digital assets or NFT's related to multimedia, however none of these patent describe a cryptographic digital assets or NFT's whose contents updates or changes. This includes U.S. patent Ser. No. 11/075,891 B1 which describes a non-fungible token (NFT) based digital rights management in a decentralized data delivery network for multimedia data, however it does not describe a cryptographic digital assets which incorporates multimedia content.

The above identified patents provide an overview of the relevant prior art upon which this patent builds, as well as an overview of the state-of-the-art at this time for cryptographic digital assets or non-fungible tokens. It will be apparent form their review that cryptographic digital assets or non-fungible tokens are being developed to address a variety of use cases, however the ability to update the multimedia contents of said asset or token remains something original which is unanticipated in the prior art.

### BACKGROUND OF THE INVENTION

Creators of traditional physical media such as music, artworks, videos, collectables, etc. have long known that their collectibles are subject to scarcity, from the fact that limited volumes of original(s) are produced in the first instance, that those originals are protected from unauthorized reproduction by intellectual property laws, and that physical originals increase in scarcity over time as the limited number that are originally produced will suffer from degradation through use or the function of time, or are destroyed as a consequence of the vagaries of existence.

Unlike traditional physical media, digital multimedia can be infinitely reproduced and each copy remains a perfect copy indefinitely, and can be replaced with a perfect copy indefinitely. Various techniques have been developed to both control reproduction of digital media, and to authenticate and control the use and transfer of digital media.

One popular method is the creation of Non-Fungible Tokens (NFT's), a cryptographically secured, distributed, decentralized, non-interchangeable unit of data stored on a blockchain (a form of digital ledger) that may be associated with a digital multimedia file.

Because each token is uniquely identifiable, NFTs provide a public certificate of authenticity, or proof of ownership, which identifies and differentiates an original limited release digital multimedia file from an otherwise identical copy, and generates scarcity of that original through that fact.

Yet no current technology has been developed to reproduce the element of deterioration over time, or through use, which traditional physical media is subject to. This reduces the experience of exclusivity and scarcity by the owner of digital multimedia, which may otherwise be present if that same person instead owned the traditional physical media equivalent.

Along related lines, the properties and qualities of traditional physical media are fixed at the time of their creation. While the underlying work may be subject to periodic updating or revision, which are integrated into subsequent releases, the physical media which is created prior remains in the state in which it was created, and typically must be replaced or structurally altered to integrate subsequent revisions or updates.

Unlike traditional physical media, digital multimedia may be easily updated by merely replacing an older version of the multimedia file with a more recent version. However NFT's, due to their structural relationship to a unique original piece of digital multimedia, do not benefit from this quality of easy updating as the replacement updated multimedia file would not have the same cryptographic qualities as the NFT certified original.

Finally traditional physical media is fixed in form at its creation, without the ability to change in a way pre-defined by the creator in relation to its ongoing existence or its relationship to its owner.

Unlike traditional physical media, digital multimedia may change in a pre-defined way through its lifetime in relation to time or aspects of its or others existence. In this way digital multimedia may, through its management, permit the incentivizing or penalizing of various activities which are otherwise not possible in the equivalent physical form of the media. However NFT's, due to their structural relationship to a unique original piece of digital multimedia, do not benefit from this ability to change as the changed multimedia would no longer have the same cryptographic qualities as the NFT certified original.

Cryptographical digital media assets such as NFT's have been developed which allow for the tracking and control through a digital ledger of physical or virtual assets and bring to digital multimedia the benefit of scarcity of a limited number of original(s), at the expense of the convenience of digitally updating or changing the digital multimedia, and the removal of the quality of increasing scarcity over time through the limiting, degradation, or destruction of the asset as a function of its use or exploitation.

This invention addresses the aforementioned shortcomings.

### SUMMARY OF THE INVENTION

The present disclosure relates generally to a computerized system and method for encoding, authenticating, transferring, consuming, accessing, playing, or displaying mutable cryptographically secured digital multimedia assets (sometimes also referred to as non-fungible tokens or NFT's), and altering those same assets by digitally updating, altering, incrementally limiting, degrading, mutating, watermarking, or eventually destroying them. It generally operates by creating, distributing, tracking and authorizing the playing, displaying, and updating of cryptographically secured digital multimedia assets, as well as a decentralized computing systems and blockchain control logic for providing the same.

### BRIEF DESCRIPTION OF DRAWINGS

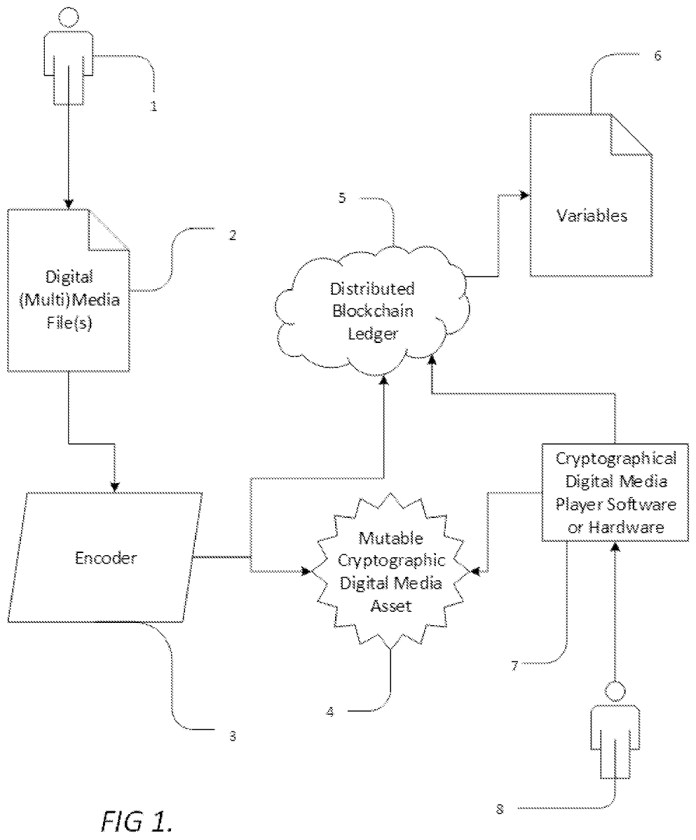

Referring to the drawing, there is shown in FIG. 1 an example of the functional structure of the method for creating the cryptographic digital media asset. As generally illustrated, a (first party) digital media creator (1) may create digital (multi)media (2) which is digitally encoded by appropriate software encoder (3) as a mutable cryptographic digital media asset (4) while creating an entry on the virtual blockchain (5) which corresponds to the mutable cryptographic digital media asset (4). The distributed blockchain object (5) records a number of variables (6) specified by the creator (1) and pertaining to the mutable cryptographic digital media asset (4). When a digital media owner (8) in possession of the mutable cryptographic digital media asset (4) seeks to consume in some way (play/display/experience/copy/transfer) the mutable cryptographic digital media asset (4) it uses the appropriate software or hardware device (7) which is capable of both accessing the cryptographic digital media asset and concurrently updating the variables (8) in the corresponding distributed blockchain ledger (5) for the activity.

Before accessing the cryptographic digital media asset (4) the cryptographic digital media player software or hardware device (7) checks against the distributed blockchain ledger's (5) relevant variables (6) whether the activity is permitted and whether changes may need to be applied to the cryptographic digital media asset (4) to update it.

### DETAILED DESCRIPTION OF THE INVENTION

This disclosure is susceptible to embodiment in various forms. Representative examples of the disclosure are shown in the drawings and will be described in detail herein with the understanding that these representative examples are provided to demonstrate the disclosed principles, not limitations of the broad aspects of the disclosure. To that extent, elements and limitations that are described in the Abstract, Technical Field, Background, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “comprising,” “having,” “containing,” and the like shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable tolerances,” or any logical combination thereof, for example.

Presented herein are mutable cryptographic digital multimedia assets for digital multimedia, methods for provisioning such items, decentralized computing systems with attendant blockchain control logic for accessing, playing, consuming, copying, transferring, or otherwise using those assets, and methods for updating the digital multimedia contents of those mutable cryptographic digital multimedia assets. As used herein, “mutable cryptographic digital multimedia assets” may refer to any digital multimedia that have a unique, non-fungible tokenized code (“token”) that are capable of being subsequently updated, and are registered on and validated by a blockchain platform or otherwise registered in an immutable database or ledger, and where the blockchain registers and tracks certain variables related to them and their use, such as being accessed, played, consumed, copied, or transferred.

After acquiring a mutable cryptographic digital multimedia assets, the owner may buy, sell, intermingle, collect, or trade it, e.g., using physical, fiat, and/or digital currency. In some examples, an entity may maintain a digital online marketplace that includes an inventory of mutable cryptographic digital multimedia assets for sale and/or a marketplace that may broker transactions between individuals.

In some embodiments the digital multimedia may be a single media item (e.g. a video, audio recording, a picture, a text) or it may be a collection of multiple media items.

To access, play, consume, copy, or transfer the mutable cryptographic digital multimedia asset the relevant software or hardware device involved first confirms that the activity is permitted by querying the associated variable on the blockchain entry. Once a permitted activity occurs the same software or hardware device may cause an update to the associated blockchain entry's variables to ensure that they accurately record the activity against the variables tracking that activity. Associated with this activity the digital multimedia contents of the mutable cryptographic digital multimedia asset may be required to be updated or mutated. When this occurs a new mutable cryptographic digital multimedia asset file is generated containing the updated digital multimedia contents, and the blockchain entry referring to the prior mutable cryptographic digital multimedia asset file is updated to refer to the new mutable cryptographic digital multimedia assets file.

In some embodiments, mutable cryptographic digital multimedia assets may be updated or mutated for the purpose of increasing scarcity. In this embodiment, the ability to access, play, consume, copy, or transfer it may be restricted once the variables tracking that activity have reached limits or quotas pre-set by the creator. Such limits or quotas may cause an update that results in the quality levels of playback (e.g. bitrates, frame rates, or resolutions) to be incrementally degraded or even eventually be restricted entirely. This limitation may occur in reference to it “running out” of permitted plays, of “time on a clock”, or permitted transfers of ownership. Similarly a mutable cryptographic digital multimedia assets may require that these aforementioned activities occur on a predefined minimum basis to retain specific qualities and avoid limitation, the threat of such limitations acting to incentivise those desired activities.

In some embodiments, mutable cryptographic digital multimedia assets may be updated for the purpose of adding additional multimedia content, or updating the existing multimedia content to a more current version. In this embodiment, the action of accessing, playing, consuming, copying, or transferring it may initiate the process to update the contents.

In some embodiments, mutable cryptographic digital multimedia assets may be updated or mutated as a result of an external activity. In this embodiment, the external activity causes an update to be made to a specific variable on the blockchain, such that the subsequent action of accessing, playing, consuming, copying, or transferring it may initiate the process to update the contents.

In some embodiments, mutable cryptographic digital multimedia assets may be altered such that the digital multimedia contents is digitally watermarked either once, or incrementally each time the action of accessing, playing, consuming, copying, or transferring occurs. In this embodiment, an update is made to a specific variable on the blockchain, such that the digital watermark and other relevant information is recorded on the blockchain. As a consequence of the digitally watermark any resultant un-encoded multimedia output (such as a recording captured by another device) can be programmatically verified at a later date as being expressed at a certain date and time, by a specific digital media owner, and related to a specific blockchain entry for a specific mutable cryptographic digital multimedia asset.

In some embodiments the mutable cryptographic digital multimedia assets may be interacted with, changed, or used to generate new derivative digital multimedia content. In this embodiment, such content may be uploaded to a middleware server, and an update made to a specific variable on the blockchain.

Referring to the drawings, FIG. 1 shows the typical process of generating mutable cryptographic digital multimedia assets whereby digital media creator (1) who wishes to generate mutable cryptographic digital multimedia assets would take their pre-existing digital (multi)media (2) and digitally encoded with an appropriate software encoder (3) the files as a single file mutable cryptographic digital media asset (4) while creating an entry on a virtual blockchain (5) which corresponds to the mutable cryptographic digital media asset (4). The distributed blockchain object (5) records a number of variables (6) specified by the creator (1) and pertaining to the mutable cryptographic digital media asset (4) and may also record programmatic rules related to the asset and the variables (such rules would typically dictate how, when and why the asset mutates throughout its existence). One of these variables is a unique digital identifier (ID) which refers to the mutable cryptographic digital multimedia asset. Typically this unique ID would be generated programmatically through a hash function such that the ID uniquely refers to a specific mutable cryptographic digital multimedia asset alone, and can be programmatically verified as such. The digital media creator would typically subsequently sell or otherwise transfer ownership of the mutable cryptographic digital media asset to a subsequent digital media owner (8). When a digital media owner (8) in possession of the mutable cryptographic digital media asset (4) seeks to access it in some way, such as to play, display, experience, copy, or transfer the mutable cryptographic digital media asset (4) it uses the appropriate software or hardware device (7) which is capable of both accessing the cryptographic digital media asset and concurrently updating the variables (8) in the corresponding distributed blockchain ledger (5) for the activity, and may also verify their identity to confirm that it is the same as that registered on the corresponding distributed blockchain ledger (5). In connection with accessing the cryptographic digital media asset (4) the cryptographic digital media player software or hardware device (7) checks against the distributed blockchain ledger's (5) relevant variables (6) whether the activity is permitted and whether changes may need to be applied to the cryptographic digital media asset (4) to update it. If the cryptographic digital media asset (4) is to be updated, then the software or hardware device (7) replaces the existing mutable cryptographic digital media asset's (4) multimedia data with the updated data, and programmatically generates a new unique ID which replaces the prior unique ID on the blockchain. Alternatively this update process may occur on a third party server, and the updated cryptographic digital media asset is then downloaded to the software or hardware player device. In this way the most up-to-date version of the mutable cryptographic digital media asset (4) is always represented by the unique digital ID on the corresponding entry on the blockchain, effectively certifying that specific cryptographic digital media asset alone as the authentic one. Otherwise, if no update is necessary, and the action sought is permitted, then the software or hardware device (7) performs the action requested, potentially updating the variables (8) if required.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a CD-ROM, a floppy disk, a hard drive, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms are described with reference to flowcharts depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims.

What is claimed:

1. A method for the generation, and maintenance of, mutable cryptographic digital multimedia assets, the method comprising:
receiving one or more pieces of digital media, henceforth termed the “digital multimedia file”, from a first party;
determining, from a database, a unique owner identification (ID) code associated with the first party;
generating a mutable cryptographic digital multimedia asset containing the digital multimedia file(s), together with a unique digital ID code;
transmitting, to a distributed blockchain ledger, the unique digital ID code and the unique owner ID code to record creation and initial ownership of the cryptographic digital asset on a transaction block, together with a number of variables and programmatically defined rules specified by the first party;
wherein the mutable cryptographic digital multimedia asset is capable of being transferred between parties; and
the mutable cryptographic digital multimedia asset is capable of being copied, transferred, accessed or played on a compatible software or hardware multimedia player device; and
whenever the mutable cryptographic digital multimedia asset is copied, transferred, accessed or played on a compatible hardware or software multimedia player device, or ownership is transferred, the action may cause associated variables registered on the blockchain to be updated; and
in connection with the update of the variables, programmatically defined rules may be executed to alter the multimedia contents of the a mutable cryptographic digital multimedia asset and update the corresponding entry on the distributed blockchain ledger to refer to the updated mutable cryptographic digital multimedia asset.

2. The method of claim 1 further comprising an update function wherein the mutable cryptographic digital multimedia asset is altered by:
updating it with additional digital multimedia content; or
removing or disabling digital multimedia content; or
updating it with higher quality digital multimedia content; or
updating it with lower quality digital multimedia content; or
updating it such that previously inaccessible digital multimedia content is rendered accessible; or
updating it such that previously accessible digital multimedia content is rendered inaccessible; or
any combination of the foregoing.

3. The method of claim 2 further comprising an update function wherein the mutable cryptographic digital multimedia asset is altered as a result of:
its transfer to a new owner; or
being accessed or played on a compatible software or hardware multimedia player device, such action capable of causing associated variables registered on the blockchain to be updated; or
being transferred to or between compatible hardware or software multimedia player devices, such action capable of causing associated variables registered on the blockchain to be updated; or
a copy being made to another compatible hardware or software multimedia player device, such action capable of causing associated variables registered on the blockchain to be updated; or
an aspect of its digital or physical environment; or
an external event; or
the passage of a pre-defined period of time; or
any combination of the foregoing.

4. The method of claim 2 further comprising an update function wherein the variables registered on the blockchain associated with the mutable cryptographic digital multimedia asset are updated:
as a result of an external activity or event occurring, such activity being notified or communicated to a computer or other device that has been configured to receive that notification; or
as a result of an external activity or event occurring, such activity being observed by a computer or other device that has been configured to observe that activity.

5. The method of claim 1 wherein the digital multimedia content of the mutable cryptographic digital multimedia asset is digitally watermarked with a unique code, such action causing associated variables registered on the blockchain to be updated with that code.

6. The method of claim 1 wherein the mutable cryptographic digital multimedia asset is accessed or played on a compatible hardware or software multimedia player device, the resultant multimedia content output is digitally watermarked with a unique code, such causing associated variables registered on the blockchain to be updated with that code.

7. The method of claim 1, further comprising:
a function whereby a mutable cryptographic digital multimedia asset being interacted with through a compatible hardware or software multimedia player device alters that digital multimedia content, or generates new digital multimedia content derived from that mutable cryptographic digital multimedia content;
such altered or new digital multimedia content being communicated to a middleware server computer to be stored; and
such action causing associated variables registered on the blockchain to be updated.

8. The method of claim 1, further comprising:
a function whereby the mutable cryptographic digital multimedia asset being played on a compatible hardware or software multimedia player device detects qualities of its physical or digital environment; and
adjusts the qualities of its playback according to its environment.

9. The method of claim 1 wherein the unique digital ID code is derived through a mathematical function applied to the mutable cryptographic digital multimedia asset.

10. A decentralized computing system for automating generation of, and maintenance of, mutable cryptographic digital multimedia assets, the decentralized computing system comprising:
a cryptographic digital asset registry storing ID codes associated with multiple cryptographic digital assets; and
a computer server operatively connected to the cryptographic digital asset registry, the computer server being programmed to:
receiving from a remote computing node, one or more pieces of digital media, henceforth termed the “digital multimedia file”, from a first party;
determining, from a database, a unique owner identification (ID) code associated with the first party;
generating a mutable cryptographic digital multimedia asset containing the digital multimedia file(s), together with a unique digital ID code;
transmitting, to a distributed blockchain ledger, the unique digital ID code and the unique owner ID code to record creation and initial ownership of the cryptographic digital asset on a transaction block, together with a number of variables and programmatically defined rules specified by the first party;
wherein the mutable cryptographic digital multimedia asset is capable of being transferred between parties; and
the mutable cryptographic digital multimedia asset is capable of being copied, transferred, accessed or played on a compatible software or hardware multimedia player device; and
whenever the mutable cryptographic digital multimedia asset is copied, transferred, accessed or played on a compatible hardware or software multimedia player device, or ownership is transferred, the action may cause associated variables registered on the blockchain to be updated; and
in connection with the update of the variables, programmatically defined rules may be executed to alter the multimedia contents of the a mutable cryptographic digital multimedia asset and update the corresponding entry on the distributed blockchain ledger to refer to the updated mutable cryptographic digital multimedia asset.

11. The method of claim 10 further comprising an update function wherein the mutable cryptographic digital multimedia asset is altered by:
updating it with additional digital multimedia content; or
removing or disabling digital multimedia content; or
updating it with higher quality digital multimedia content; or
updating it with lower quality digital multimedia content; or
updating it such that previously inaccessible digital multimedia content is rendered accessible; or
updating it such that previously accessible digital multimedia content is rendered inaccessible; or
any combination of the foregoing.

12. The method of claim 11 further comprising an update function wherein the mutable cryptographic digital multimedia asset is altered as a result of:
its transfer to a new owner; or
being accessed or played on a compatible software or hardware multimedia player device, such action capable of causing associated variables registered on the blockchain to be updated; or
being transferred to or between compatible hardware or software multimedia player devices, such action capable of causing associated variables registered on the blockchain to be updated; or
a copy being made to another compatible hardware or software multimedia player device, such action capable of causing associated variables registered on the blockchain to be updated; or
an aspect of its digital or physical environment; or
an external event; or
the passage of a pre-defined period of time; or
any combination of the foregoing.

13. The method of claim 11 further comprising an update function wherein the variables registered on the blockchain associated with the mutable cryptographic digital multimedia asset are updated:
as a result of an external activity or event occurring, such activity being notified or communicated to a computer or other device that has been configured to receive that notification; or
as a result of an external activity or event occurring, such activity being observed by a computer or other device that has been configured to observe that activity.

14. The method of claim 12 wherein the digital multimedia content of the mutable cryptographic digital multimedia asset is digitally watermarked with a unique code, such action causing associated variables registered on the blockchain to be updated with that code.

15. The method of claim 12 wherein the mutable cryptographic digital multimedia asset is accessed or played on a compatible hardware or software multimedia player device, the resultant multimedia content output is digitally watermarked with a unique code, such causing associated variables registered on the blockchain to be updated with that code.

16. The method of claim 12, further comprising:
a function whereby a mutable cryptographic digital multimedia asset being interacted with through a compatible hardware or software multimedia player device alters that digital multimedia content, or generates new digital multimedia content derived from that mutable cryptographic digital multimedia content;
such altered or new digital multimedia content being communicated to a middleware server computer to be stored; and
such action causing associated variables registered on the blockchain to be updated.

17. The method of claim 12, further comprising:
a function whereby the mutable cryptographic digital multimedia asset being played on a compatible hardware or software multimedia player device detects qualities of its physical or digital environment; and
adjusts the qualities of its playback according to its environment.

18. The method of claim 12 wherein the unique digital ID code is derived through a mathematical function applied to the mutable cryptographic digital multimedia asset.
